(19) United States
(12) Patent Application Publication
(10) Pub. No.: US 2026/0218800 A1
(43) Pub. Date: Jul. 30, 2026

(54) METHOD AND ARRANGEMENT FOR DETERMINING FLUID PATH CONNECTIVITY

(71) Applicant: TECAN TRADING AG GLOBAL INTELLECTUAL PROPERTY, Männedorf (CH)

(72) Inventor: Artin BARSEGHIAN, Fremont, CA (US)

(21) Appl. No.: 19/140,218

(22) PCT Filed: Dec. 19, 2023
(86) PCT No.: PCT/US2023/084794

§ 371 Date: Jun. 17, 2025

(30) Foreign Application Priority Data
Dec. 22, 2022 (WO) PCT/US2022/053831

(51) Int. Cl. F16K 11/074; F16K 37/00; G01M 13/003

(52) U.S. Cl. CPC F16K 11/0743; F16K 37/0083; G01M 13/003

(57) ABSTRACT

The invention relates to a method of determining fluid path connectivity for a fluidic device having a static member (214) and a moveable member (224), whereby the static member has a first channel (248) with a first port opening (249) that is interconnectable with a second port opening (250b) of a second channel (250) in the moveable member, and whereby said channels are interconnectable so as to create at least part of a fluid path (280). The method comprises steps of: —generating an acoustic signal at one end of the fluid path; —receiving the generated acoustic signal at an opposite end of the fluid path; —measuring an acoustic intensity of the received signal; and —moving the moveable member relative to the static member, such that the first and second port openings move into and out of alignment with each other. The step of measuring the acoustic intensity is performed during step of moving and fluid path connectivity is determined by correlating the measured acoustic intensity with a center-to-center alignment of the first and second port openings

### FIELD OF THE INVENTION

The invention relates to a method of determining one or more fluid path positions for a fluidic device comprising at least first and second channel sections which are moveable relative to each other and which are interconnectable so as to form at least part of a fluid path. The invention further relates to apparatuses for testing and calibrating such fluidic devices.

### BACKGROUND ART

An example of a device comprising an interconnected fluid path is a rotary value. Rotary valves may be used in laboratory automation systems for distributing liquids, such as reagents, dilutions, samples, etc. A rotary valve usually comprises a stator member with stator channels and a rotor member, which comprises a rotor channel. Dependent on different rotary positions, the rotor channel interconnects different stator channels with each other. A pump may convey a liquid from a first container and/or channel into the rotary valve and the rotary valve may distribute the liquid into other containers and/or channels dependent on its rotor position. The rotary valve also may draw from one of a plurality of source containers and may distribute the fluid into a common outlet.

Microfluidic and flow cell applications require precise, constant flow rates and clean “cut over” between fluids with minimal flushing of prior reagents from the lines. For this, a highly precise alignment between the openings of the stator channels and the rotor channel is required. A method and apparatus to identify fluidic path positions of a rotary valve is disclosed in US2020/108386. The rotary valve is rotated via a testing system to a plurality of rotary valve positions. A fluidic parameter is measured at each rotary valve position and is mapped relative to the rotary valve positions. The measured fluidic parameter is a pressure parameter or a mass flow parameter. It is determined from the mapping if the rotary valve aligns with each of the predetermined port positions for a flow of reagents through the channels.

There is room for improvement in terms of defining a method of determining fluid path position which does not rely of the measurement of fluid parameters.

### SUMMARY OF THE INVENTION

In a first aspect, the present invention defines a method of determining fluid path connectivity for a fluidic device which has a moveable member and a static member and comprises first and second channels that are interconnectable to create at least part of a fluid path. The first channel is provided in the static member and the second channel is provided in the moveable member, whereby the first channel has a first port opening that interfaces with a second port opening of the second channel.

The method is based on the understanding that the fluid path also forms a path for sound travel and comprises steps of generating an acoustic signal at one end of the fluid path, receiving the generated signal at an opposite end of the fluid path and measuring an acoustic intensity of the received signal. An acoustic signal generator may be arranged in one of the channels, or in connection therewith, while an acoustic receiver is arranged in the other channel or in connection therewith.

When the fluid path is blocked, no acoustic signal will be detected. Misalignment will also affect the measured acoustic intensity. In an optimally aligned position of the port openings, a condition of optimal fluid path connectivity exists and the measured acoustic intensity will have a maximum value. If the port openings are only partially aligned, the measured acoustic intensity will be smaller.

The method further comprises a step of moving the moveable member relative to the static member, such that the first and second port openings come into and out of alignment with each other. The acoustic intensity associated with the created fluid path is measured during the step of moving, and is thus indicative of a degree of centre-to-centre alignment between the port openings and of fluid path connectivity. The step of measuring may be performed simultaneously with the step of moving. Alternatively, the moveable member may be moved in incremental steps, followed by a measurement of the associated acoustic intensity. The method comprises a further step of correlating the measured acoustic intensity with a degree of centre-to-centre alignment of the port openings.

The method may also be used to identify the optimally aligned position of the first port opening relative to the second port opening, based on the measured acoustic intensity.

The fluidic device is suitably provided with a position encoder for generating a position signal that is indicative of the position of the moveable member relative to the static member. The method then further comprises receiving the position signal and recording the position at which different acoustic signal intensities are measured. The optimally aligned position is then determined based on the measured acoustic signal.

This may be done by identifying the position at which maximum acoustic intensity is measured. Additionally, or alternatively, the edges of the moveable port opening may be detected when the measured signal rises above a minimum threshold value, as the channel port openings come into partial alignment with each other, and then fall below the minimum threshold as the port openings move out of alignment into a blocked position. The optimally aligned position of the port openings is then determined as a central position between the measured location of the edges.

In some embodiments, the fluidic device is a linear valve comprising a moveable member that is linearly displaceable relative to a static member. The linear valve suitably comprises a linear displacement mechanism and a controller for controlling the linear position of the moveable member, based on a position signal received from a position encoder comprising a sensor that is mounted to one of the movable member and the static member. The linear valve further comprises a primary channel, which is provided in one of the moveable member and the static member, and plurality of selectable secondary channels which are provided on the other of the static member and the moveable member. A plurality of fluid paths is thus creatable by linearly displacing, e.g., shifting or sliding, a port opening of the primary channel into alignment with a port opening of a selected secondary channel or vice-versa.

The method comprises linearly displacing the moveable member, such that the port opening of the primary channel is moved relative to the port opening of each selectable secondary channel. The acoustic intensity associated with each created fluid path is measured, while measuring and recording the linear position of the moveable member, and a position of optimal center-to-center alignment for the port opening of the primary channel and the port opening of each secondary channel is determined, based on the measured acoustic intensity. Preferably, acoustic intensity is measured for each created fluid path while the moveable member is linearly displaced in a “forwards” direction and in a “backwards” direction, to eliminate hysteresis effects of the overall system. The optimal position that is determined in both directions may then be averaged and stored as the position of optimal alignment for bringing the port opening of the primary channel into center-to-center alignment with the port opening of each selectable secondary channel. Alternatively, the optimal position determined in each direction individually may be used to position to the relevant port opening, dependent on the direction of linear displacement that is applied.

In other embodiments, the fluidic device is a rotary valve, whereby the moveable member is a rotor member comprising a rotor channel and the static member is a stator assembly comprising a plurality of selectable stator channels. The rotary valve is suitably provided with a position encoder for providing a position signal that is indicative of the angular position of the rotor member relative to the stator assembly, and a controller for controlling the rotation of the rotor member based on the position signal.

The method comprises rotating a port opening of the rotor channel past the port opening of each selectable stator channel and measuring the acoustic intensity associated with each created fluid path, while measuring and recording the angular position of the rotor member. A position of optimal center-to-center alignment for the port opening of the rotor channel and the port opening of each stator channel is determined, based on the measured acoustic intensity. Preferably, acoustic intensity is measured for each created fluid path while the rotor member is rotated in a clockwise direction and in an anticlockwise direction, to eliminate hysteresis effects of the overall system. The optimal position that is determined in both directions may then be averaged and stored as the position of optimal alignment for bringing the port opening of the rotor channel into center-to-center alignment with the port opening of each selectable stator channel. Alternatively, the optimal position determined in each direction individually may be used to position to the port opening, dependent on the direction of rotation that is applied.

In both cases, when the fluidic device is a linear valve or a rotary valve, because the acoustic signal is analyzed relative to the position of the moveable member, the method is independent of fluid properties and will work with any fluid, including air, water and e.g. reagents.

The linear valve or the rotary valve may thus be programmed with corresponding encoder values, for controlling the linear displacement of the moveable member or for controlling rotation of the rotor member during use of the valve in question, to ensure an optimally aligned position when a specific fluid path is selected.

The aforementioned programming may be performed prior to sale of the linear valve or the rotary valve with the aid of a specially adapted test arrangement. If recalibration becomes necessary after use of the valve, the method can be repeated by integrating a measuring arrangement in a fluidic system that comprises the rotary valve or linear valve.

In further aspect, the invention provides an apparatus for testing and calibrating a linear valve or a rotary valve.

In an embodiment where the valve is a rotary valve as described above, the apparatus comprises an analysis device and a measurement fixture which has a central opening that is connectable to the central stator channel of the valve's stator assembly and has a plurality of outer openings, each of which is connectable to a corresponding stator channel of the stator assembly. The central opening of the measuring fixture is provided with one of an acoustic transmitter and an acoustic receiver, and each outer opening of the measuring fixture is provided with the other of an acoustic receiver and an acoustic transmitter, such that an acoustic signal associated with each created fluid path is measurable. The analysis device is configured to measure the acoustic intensity of the received signal during rotation of the rotor port opening past each selectable stator port opening.

The analysis device may be further configured to receive and record a position signal from the rotary encoder during the measurement, and to determine a position of optimal center-to-center alignment for the rotor port opening and each stator port opening, based on the acoustic signal measured for each created fluid path.

Alternatively, the analysis device may be configured to detect when the measured signal rises above and falls below a threshold, and to provide a corresponding digital high/low signal to the rotary encoder of the valve.

In an embodiment where the valve is a linear valve as described above, the apparatus for testing and calibration of the linear valve comprises a measuring fixture which has a static part for holding the static member of the valve and a moving part for holding the moveable member. When the static member comprises the primary channel, the static part of the fixture is provided with one of an acoustic transmitter and an acoustic receiver that is arranged in closed connection with the primary channel. The moving part of the fixture, comprising the plurality of secondary channels, is then provided with a corresponding plurality of the other of an acoustic transmitter and an acoustic receiver, each of which is arranged in closed connection with the corresponding secondary channel.

When the moveable member of the valve comprises the primary channel, the moving part of the measuring fixture is provided with one of an acoustic transmitter and an acoustic receiver, and the static part is provided with a plurality of the other of an acoustic transmitter and acoustic receiver, each of which is arranged in closed connection with the corresponding secondary channel in the static member of the valve.

The apparatus further comprises an analysis device configured to measure the acoustic intensity of the received signal associated with each created fluid path during linear displacement of the moveable member.

The analysis device may be further configured to receive and record a position signal from the position encoder during the measurement, and to determine a position of optimal center-to-center alignment for the port opening of the primary channel and the port opening of each secondary channel, based on the acoustic signal measured for each created fluid path.

Alternatively, the analysis device may be configured to detect when the measured signal rises above and falls below a threshold, and to provide a corresponding digital high/low signal to the position encoder of the linear valve.

The analysis device used in the method and apparatuses of the invention may be an oscilloscope, a threshold-comparing circuit or a computer-based data acquisition system.

The acoustic transmitter(s) used in the method and apparatuses of the invention emits an acoustic signal, preferably with an ultrasonic frequency of greater than 20 KHz. Acoustic intensity may be measured by measuring a peak-to-peak amplitude of the received signal. Additional properties of the received acoustic signal, such as frequency tuning, echoes, harmonics or total harmonic distortion may also be measured, to detect the presence of e.g. debris resulting from drilling of the connection ports and channels during manufacture of the rotary or linear valve.

The method and apparatuses of the invention thus provide for straightforward and reliable determination of fluid path connectivity, enabling optimal fluid path positions to be measured and established during testing and calibration of a linear valve or a rotary valve.

These and other aspects of the invention are apparent from and will be elucidated with reference to the embodiments described hereinafter and with reference to the accompanying drawings.

### BRIEF DESCRIPTION OF THE DRAWINGS

FIG. 1 shows a perspective sectional view of a rotary valve, being an example of a product on which the method of the invention may be implemented;

FIG. 2 schematically shows part of a rotor member and a stator member of a further example of a rotary valve, including parts of a measuring arrangement for implementing the method of the invention;

FIG. 3a depicts a side cross-sectional view of a measuring fixture for implementing an embodiment of the inventive method for determining optimal fluid path connectivity and alignment of fluid paths in a rotary valve as depicted in FIG. 2;

FIG. 3b depicts a top cross-sectional view of part of the measuring arrangement of FIG. 3a

FIGS. 4a and 4b show a schematic representation of a linear valve and components of a measuring arrangement for implementing the method of the invention.

FIG. 5a is a schematic sectional view of a further example of a linear valve.

FIG. 5b is a schematic sectional view of a measuring fixture for implementing an embodiment of the inventive method for determining optimal fluid path connectivity and alignment of fluid paths in the linear valve of FIG. 5a.

It should be noted that items which have the same reference numbers in different figures, have the same structural features and the same functions. Where the function and/or structure of such an item has been explained, there is no necessity for repeated explanation thereof in the detailed description.

### DETAILED DESCRIPTION OF EMBODIMENTS

The method of the invention is particularly suitable for use in determining fluid path positions in a product such as a rotary valve or a linear valve and will be described in detail in relation to such products, for illustrative purposes.

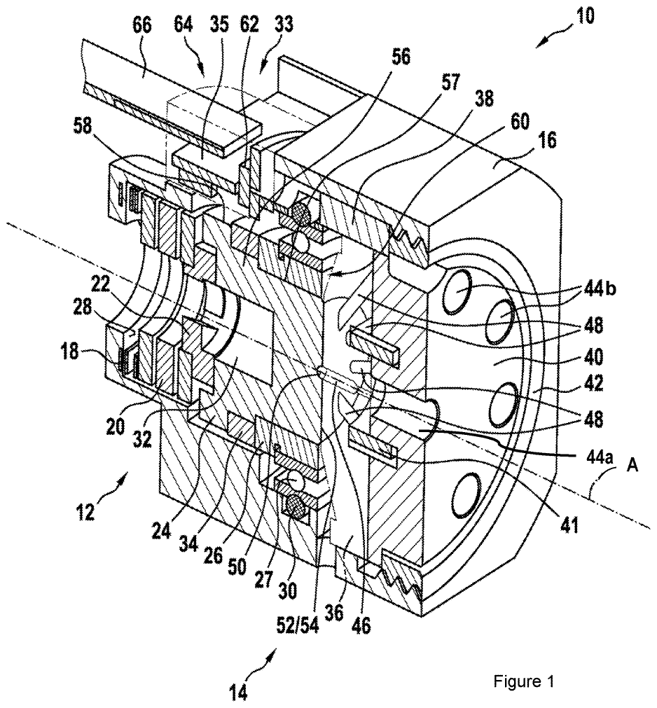

FIG. 1 shows a rotary valve 10 with a rotor assembly 12 and a stator assembly 14 in a housing 16. The rotor assembly 12 comprises a spring element 18, a bearing 20 (such as a thrust bearing), a coupler 22, a rotor member 24, sleeve 26, and a radial bearing 27. The spring element 18, which lies on an annular cavity 28 of the housing 16, presses the rotor member 24 via the bearing 20 and the coupler 22 against the stator assembly 14. A sealing ring 30 provides a tightening between the rotor assembly and the housing 16.

The rotor member 24 is rotatably mounted to the bearing 20 and rotatably mounted inside the radial bearing 27. The rotor member 24 is adapted to rotate about a rotation axis A. Through the annular cavity 28, a shaft of a gear and/or an electrical motor may be mounted into the coupler 22 and into an opening 32 of the rotor member 24.

The rotary valve 10 is provided with a rotary encoder assembly 33, which comprises an encoder member 34, which is mounted to the rotor member 24 beside the radial bearing 27, and an encoder module 35, which is mounted to the housing 16. The encoder member 34 is rigidly connected to the rotor member 24 and surrounds the rotor member 24. For example, the encoder member may be molded and/or held in place by bonding or other parts to the rotor member 24.

The stator assembly 14 comprises a stator member 36, which is fixed to the housing 16. A pin 38 prevents a rotation of the stator member 36. A port member 40 of the stator assembly 14 is arranged and aligned on the stator member 36 via alignment ring (or pins) 41 and fixed into the housing with a screw ring 42. The port member 40 comprises connection ports 44a, 44b for connecting lines or hoses to the rotary valve 10. The connection ports are substantially cylindrical openings extending parallel to the rotation axis.

The stator member 36 comprises a central stator channel 46, which enters into a central, or common port 44a of the port member 40. The stator member further comprises a plurality of selectable stator channels 48 arranged radially outward of the central stator channel, which enter into outer connection ports 44b of the port member 40. The rotor member 24 comprises a rotor channel 50, which in specific rotor positions interconnects the central stator channel 46 with one of the selectable stator channels 48. In such a rotor position, a fluid can flow from the common port 44a to one of the outer ports 44b or vice versa. In other positions, the fluid flow may be blocked.

The rotor member 24 has a planar, disk-shaped rotor face 52 in which the rotor channel 50 is provided as a groove. The stator member 36 has a planar, disk-shaped stator face 54, which faces and is in contact with the rotor face 52. The spring element 18 presses the rotor face 52 against the stator face 54, such that a fluid tight connection is generated.

The rotor member 24 comprises a cylindrical body 56 with the opening 32 for receiving a shaft at one end and a rotor body 57 providing the rotor face 52 at the other end. The bodies 56 and 57 may be made from the same material and/or may be made in one piece. The rotor face 52 as well as the stator face 54 is aligned orthogonal to the axis of rotation.

The coupler 22 is attached into the opening 32. The encoder member 34 is attached to an outer surface of the cylindrical body 56, wherein the encoder member 34 surrounds the opening 32.

The encoder member 34 is arranged between the bearing sleeve 26 and a flange 58 of the rotor member 24. The ring-shaped flange 58 runs around the cylindrical body 56 of the rotor member 24. At an inner side, the flange 58 accommodates the coupler 22.

The stator member 36 comprises a circular groove 60 surrounding the stator face 54. A part of the bearing 27 protrudes into the circular groove 60, which is used for collecting fluid, which may leave the room between the rotor face 52 and the stator face 54.

The encoder member 34 may be a ring-shaped magnet. The rotary position of the rotor member 24 may be evaluated by the encoder module 35 by sensing magnetic poles of the encoder member 34. In the case of a magnetic encoder member 34, the encoder member 34 may be completely molded into a mold material for molding it to the rotor member 24.

The encoder member 34 may comprise magnetic poles and the encoder module 35 may be adapted for sensing the magnetic poles with a sensor 62. The sensor 62 may be a Hall sensor. For example, the encoder member 34 comprises 8 magnetic pole pairs for determining a relative position and one index pole for determining an absolute position. This may result in a resolution of about 4000 to 16000 steps for 360°.

In general, the encoder member 34 comprises or is a ring surrounding the rotor member 24, which provides an encoding of a rotational position of the rotor member 24. Such an encoding may be provided magnetically or optically. As a further example, the encoder member 34 may comprise a ring with openings, wherein light, which runs through the openings or which is shielded by the ring between the openings, is sensed by the sensor 62, which in this case may be an optical sensor.

The encoder module 35 further may comprise circuitry 64 for evaluating the signal of the sensor 62 and for generating a digital signal encoding the angular position, which then may be sent via a cable 66 to a controller for controlling the rotary valve 10.

The rotor member 24 is rotated to a predetermined angular position, stored in a main control board of the rotary valve controller, such that the rotor channel 50 interconnects the central stator channel 46 with one of the selectable stator channels 48, thereby creating a fluid path.

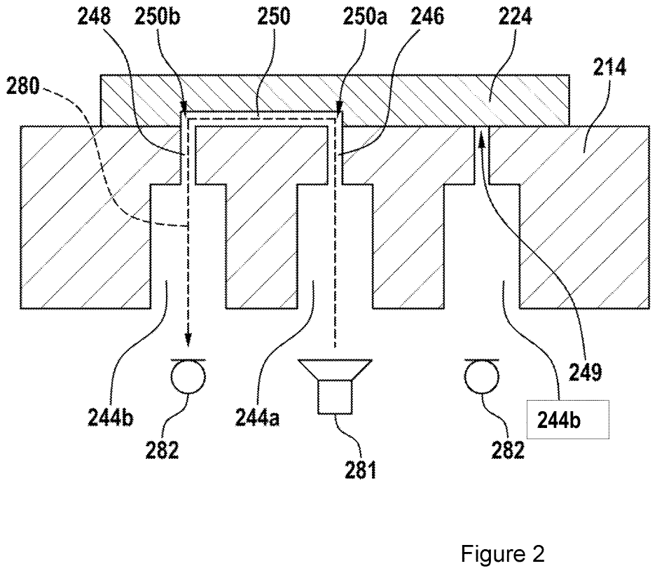

FIG. 2 schematically depicts part of the rotor member 224 and the stator assembly 214 of a further example of a rotary valve. In the depicted example, the stator assembly is a single part in which the stator channels 246, 248 and the corresponding connection ports 244a, 244b are integrated. The connection ports may comprise threaded inserts (not shown) for the attachment of tubing. The rotor channel 250 extends in radial direction between a central port opening 250a and a radially outer port opening 250b in the face of the rotor member 224. The central opening 250a is in connection with the central stator channel 246, which in turn is in connection with the common port 244a. The rotor member is depicted in a predetermined angular position in which the radially outer opening 250b is in connection with a corresponding port opening of a first selectable stator channel 248 and the corresponding connection port 244b. Each selectable stator channel has a port opening 249. To ensure optimal connectivity of the created fluid path, the exact angular position of the corresponding stator channel opening must be known, so that the outer opening 250b of the rotor channel can be rotated into alignment therewith. This can be achieved by manufacturing the rotor member and the stator assembly with precise tolerances, which is prohibitively expensive. Moreover, it remains possible that after prolonged use of such a rotary value, misalignments might occur that result in stored encoder values no longer bringing the necessary channels into precise alignment with each other.

It is thus beneficial to measure fluid path connectivity, to enable detection of optimal connectivity between interconnected channels or loss of optimal connectivity, so that corrections can be implemented.

In accordance with the method of the invention, fluid path connectivity is determined by measuring acoustic intensity. With regard to the examples of the rotary valve as depicted in FIGS. 1 and 2, the method can be used to determine optimal fluid path connectivity and associate this with an angular position of the rotor and encoder at which optimal connectivity occurs.

In one example, an acoustic transmitter, e.g. an ultrasonic transmitter 281 is arranged in a closed connection channel with the common port 244a so as to emit an ultrasonic signal of e.g. 40 kHz. Suitably, each selectable connection port 244b is provided with an ultrasonic receiver 282. In FIG. 2, which shows the common port 244a in fluid communication with the first selectable port via the rotor channel 250, the fluid path depicted by dotted line 280 can be considered as a path for sound travel. The amplitude of the acoustic signal detected by the receiver 282 provides a measure for the degree of connectivity of the fluid path, which in turn corresponds to a degree of alignment of the outer opening 250b of the rotor channel with the opening 249 in the selectable stator channel.

The received signal typically has maximum amplitude when the outer opening 250b of the rotor channel is optimally aligned with the opening in the selectable stator channel. A signal of smaller amplitude is received when the respective openings are in partial alignment and no signal is detected when the fluid path is blocked. The received signal may be a sinusoidal signal and a peak-to-peak signal amplitude may be measured.

In order to determine the position of optimal alignment associated with each fluid path, a test is conducted in which the acoustic signal received by each receiver is measured while the rotor member is rotated, bringing the outer opening 250b of the rotor channel into and out of alignment with the opening 249 of each of the selectable stator channels 248. Simultaneously, the angular position of the rotor member is recorded by an angular position encoder comprising an encoding member mounted in connection with the rotor member.

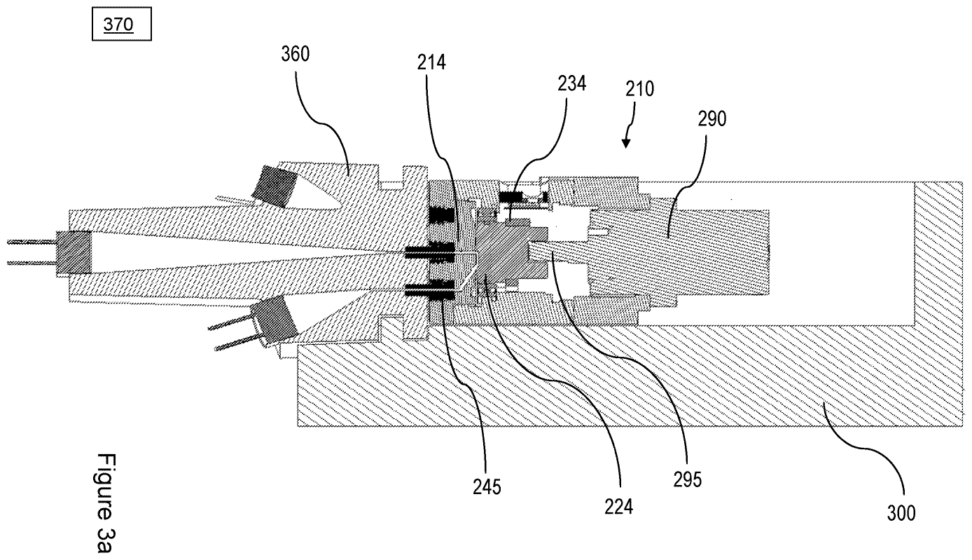

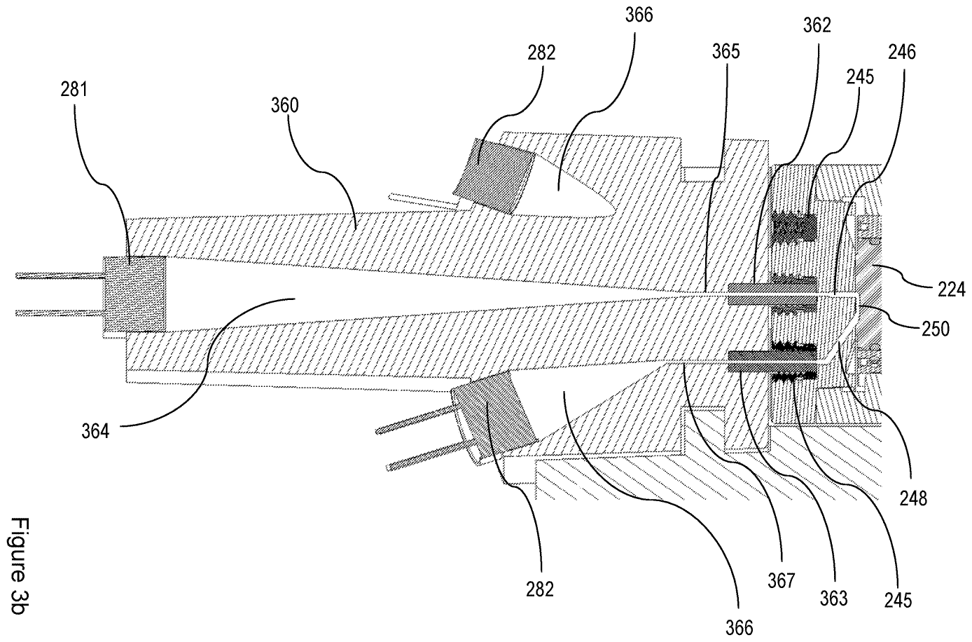

The test may be performed by mounting the rotary valve to a teaching fixture, forming part of a measuring arrangement such as depicted in side cross-sectional view in FIG. 3a. A larger view of the teaching fixture and part of the rotary valve is shown in FIG. 3b

The rotary valve 210 is arranged in a holder 300, which also accommodates the teaching fixture 360 such that an axial end face of the teaching fixture is in contact with an axial end face of the stator assembly 214. In the depicted example, the stator assembly is a single part in which the stator channels and connection ports are integrated, such as schematically depicted in FIG. 2. The connection ports 224a, 224b (refer FIG. 2) are provided with threaded inserts 245. The teaching fixture further comprises a central protrusion 362 that fits into the common port 244a of the stator assembly 214 and a number of radially outer protrusions 363 that fit into the selectable connection ports 244b. The protrusions may be integrally formed with the teaching fixture or may by formed by separate connection tubes that fit into the threaded inserts 245.

The teaching fixture has a central opening 364, which may comprise a conical section that tapers towards a central channel section 365 that extends through the central protrusion 362 and connects with the central stator channel 246. The ultrasonic transmitter 281 may be arranged in a plug that closes the central opening 364. The teaching fixture further comprises a larger diameter flange part, which has a number of second openings 366 arranged with an angular spacing at a radially outer location relative to the central opening 364. Each of the radially outer openings may be conical in shape, tapering towards a second channel section 367 that extends through the protrusion 363 and into a selectable port of the stator assembly and connects with the corresponding selectable stator channel 248. Furthermore, each of the radially outer openings 366 is provided with an ultrasonic receiver 282, suitably arranged in a plug that encloses the opening.

Thus, the transmitter 281 emits an ultrasonic signal that travels via the central opening 364 and central channel 365 of the teaching fixture 360 into the central stator channel 246 and along the rotor channel 250. When the radially outer port opening 250b (refer FIG. 2) of the rotor channel is at least in partial alignment with the port opening 249 of a selectable stator channel 248, the ultrasonic signal is able to travel along the second channel section 367 and second opening 366 of the teaching fixture, where it is detected by the corresponding receiver 282.

During the test, the rotor member is rotated by a drive shaft 295 of a motor 290 of the rotary valve. The test arrangement further comprises an analysis device such as an oscilloscope, a threshold-comparing circuit or computer-based data acquisition system, schematically depicted in FIG. 3a with reference numeral 370, which receives and measures the signals from each ultrasonic receiver 282. In addition, the analysis device 370 may receive the angular position signal from an encoder module which detects the position of a rotary encoder 234 mounted on the rotor member 224. Alternatively, the analysis device 370 may be configured to provide an input to the encoder module, which suitably comprises firmware that is programmed to store a position based on the received input.

As the rotor member 224 is rotated, the port opening 250b (refer FIG. 2) of the rotor channel 250 comes into and out of alignment with the port opening 249 of each selectable stator channel 248. In an embodiment of the method, the angular position at which a particular receiver 282 measures maximum signal amplitude is determined to be the position of optimal alignment. Preferably, the test is conducted by rotating the rotor member 224 in clockwise and anticlockwise direction, to minimize hysteresis effects. In an embodiment, an average is taken of the recorded angular position associated with maximum signal amplitude measured by each receiver in each direction and stored as the optimal position of center-to-center alignment.

Alternatively, the position of optimal alignment may be determined based on the direction of rotation, whereby the recorded angular position associated with maximum signal amplitude in a particular direction is stored as an encoder value to bring the rotor channel into alignment with a selected stator channel when rotation occurs in that direction.

In a further alternative embodiment, the edges of a stator port opening are detected. As mentioned, no acoustic signal is received when the outer port opening 250b of the rotor channel is completely out of alignment with a stator port opening 249. A measurable signal is received as soon as a path for the acoustic signal exists, which allows a first edge of the port opening 249 to be detected. The method may thus comprise recording the angular position at which the measured signal rises above a predetermined threshold. The measured signal will fall to zero when the rotor opening 250b moves completely out of alignment with the selectable stator port opening 249. The angular position at which the measured signal drops below the predetermined threshold may also be recorded, in order to identify the position of a second edge of the port opening. The position of optimal center-to-center alignment is then determined to be a midpoint between the recorded position for the first and second edges. Again, the test is preferably conducted by rotating the rotor member 224 in both directions and an average of the determined midpoints is taken.

In a still further embodiment, the rotor member is rotated in one direction and the angular position at which the measured signal from each receiver 282 rises above the threshold is recorded and stored as the angular position of the first edge of each stator port opening 249. The analyzer 370 may be programmed to detect that the measured signal has fallen below the threshold, which is used as a reset to indicate that a next measurement at which the signal rises above the threshold is expected. When the position of the first edge of each stator port opening 249 has been recorded, the rotor member is then rotated in the opposite direction. Again, the angular position at which the measured signal from each receiver 282 rises above the threshold is recorded and stored as the angular position of the second edge of each stator port opening 249. The position of optimal center-to-center alignment is then determined as the midpoint between the first and second edge positions recorded for each stator port opening 249.

In embodiments where the edges of a stator port opening are detected via thresholding, the analysis device 370 may be configured to convert the received acoustic signal into a simple digital high/low signal that is received as an input by the encoder module, which is programmed to determine the position of optimal alignment for each stator port opening as described above.

The method may further comprise measuring other properties of the received acoustic signals, such as such as frequency tuning, echoes, harmonics or total harmonic distortion to detect the presence of e.g. debris resulting from drilling of the connection ports and channels during manufacture of the rotary valve.

When the angular position associated with optimal alignment for each stator connection port has been determined, the corresponding encoder value is stored in the control electronics of the rotary valve. This can be done immediately after manufacture of the rotary valve and prior to sale, such that the customer receives a product that has been “taught” which rotary position to adopt in order to achieve optimal connectivity with each selectable connection port.

A similar method may be employed after use of the rotary valve, to check whether the initially stored encoder values remain optimal.

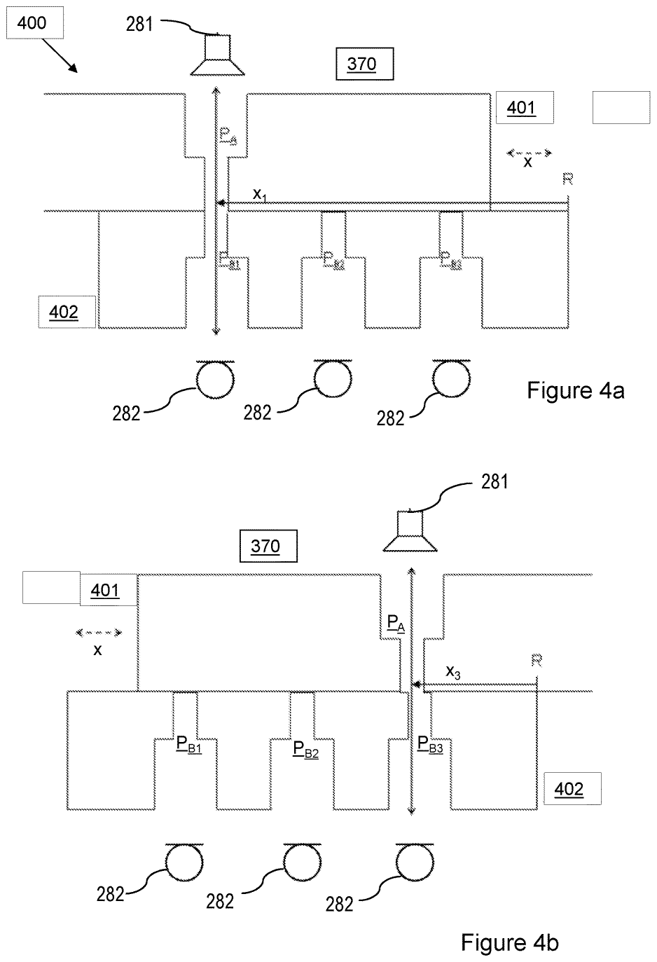

Instead of performing a rotary motion in order to connect a rotor channel with a certain one of a plurality of circularly arranged stator channels, a linear shifting or linear sliding motion may be employed to connect an input channel with one of several linearly arranged output channels (or conversely one of several input channels with an output channel). This can be achieved by means of a linear valve, an example of which is schematically depicted in FIGS. 4a and 4b, including components of a test arrangement for determining the position of optimal fluid path connectivity associated with each creatable fluid path.

FIG. 4a shows a linear valve 400 with a movable upper member 401 that is linearly displaceable in x direction (indicated by the horizontal dashed double-arrow) relative to a fixed reference point R located on a static member 102 of the valve. The moveable member 401 in the depicted example has a primary connection port P_{A} and the static member has a plurality of selectable connection ports P_{B1}, P_{B2}, P_{B3}. As will be understood, the linear valve has a linear drive mechanism to which the moveable member 401 is mounted and controller for controlling the drive mechanism and the linear position of the moveable member.

The connection port P_{A} of the upper movable member 401 may thus be brought into alignment with any one of the ports P_{B1}, P_{B2}, P_{B3} of the lower static member 402. In the depicted example, port P_{A} has been brought into exact alignment with port P_{B1} by moving the upper member 401 of the linear valve 400 to the right by a distance x₁, thus allowing an unrestricted flow of fluid between the upper and lower members of the linear valve (indicated by the vertical double-arrow). A position encoder (not shown in FIG. 4a) determines the position of the upper movable member 401 relative to the reference position R at the lower static member 402, and suitably provides a position signal to the device controller. Typically, the moving member is provided with an encoding member, the movement of which is detected by a sensor provided on the static member.

FIG. 4b illustrates a situation where the moveable member 401 has been moved in order to bring its port P_{A} into connection with port P_{B3} of the static member 402. When the moveable member 401 is located at position x₃ the two ports P_{A} and P_{B3} are merely overlapping but not fully aligned, such that the fluid path connectivity is only partially established. This can be determined reliably using the proposed method for determining fluid path connectivity.

An acoustic transmitter 281 may be arranged in a closed connection path with the port P_{A} in the movable upper member 401, while an acoustic receiver 282 is arranged in a closed connection path with each of the selectable ports P_{B1}, P_{B2}, P_{B3} of the lower static member 402. Alternatively, an acoustic receiver may be provided in connection with the port P_{A}, while an acoustic receiver 282 is provided in connection with each of the selectable ports P_{B1}, P_{B2}, P_{B3}.

In order to determine the position of optimal alignment associated with each fluid path, a test is conducted in which the acoustic signal received by each receiver 282 is measured by an analysis device 370 during displacement of the upper moveable member 401 relative to the static lower member, which brings the primary port P_{A} into and out of alignment with each of the selectable ports P_{B1}, P_{B2}, P_{B3} of the lower static member 402. Simultaneously, the position of the moveable member relative to the reference R is recorded by the position encoder.

As described with reference to the embodiment involving a rotary value, the position at which a particular receiver 282 measures maximum signal amplitude may be determined to be the position of optimal alignment. Preferably, the test is conducted by displacing the moveable member 101 in both x-directions, i.e. forwards and backwards (left and right), to minimize hysteresis effects. An average may be taken of the recorded position associated with maximum signal amplitude measured by each receiver in each direction and stored as the optimal position of center-to-center alignment.

Alternatively, the position of optimal alignment may be determined based on the direction of displacement, whereby the recorded position associated with maximum signal amplitude in a particular direction is stored as an encoder value to bring the port P_{A} into alignment with each selectable port P_{B1}, P_{B2}, P_{B3} when linear displacement occurs in that direction.

In a further alternative embodiment, the edges of each selectable port P_{B1}, P_{B2}, P_{B3} are detected, whereby the method comprises recording the position at which the measured signal rises above a predetermined threshold and identifying this position as a first edge of a selectable port. The position at which the measured signal drops below the predetermined threshold may also be recorded, in order to identify the position of a second edge of the port. The position of optimal center-to-center alignment is then determined to be a midpoint between the recorded position for the first and second edges. Again, the test is preferably conducted by displacing the moveable member 101 in both linear directions and an average of the determined midpoints is taken.

In a still further embodiment, the moveable member 401 is displaced in one direction and the position at which the measured signal from each receiver 282 rises above the threshold is recorded and stored as the position of the first edge of each selectable port. The analyzer 370 may be programmed to detect that the measured signal has fallen below the threshold, which is used as a reset to indicate that a next measurement at which the signal rises above the threshold is expected. When the position of the first edge of each selectable port P_{B1}, P_{B2}, P_{B3} has been recorded, the moveable member 401 of the linear valve is then displaced in the opposite linear direction. Again, the position at which the measured signal from each receiver 282 rises above the threshold is recorded and stored as the position of the second edge of each selectable port. The position of optimal center-to-center alignment is then determined as the midpoint between the first and second edge positions recorded for each selectable port P_{B1}, P_{B2}, P_{B3}.

In embodiments where the edges of a selectable port are detected via thresholding, the analysis device 370 may be configured to convert the received acoustic signal into a simple digital high/low signal that is received as an input by the position encoder, which is programmed to determine the position of optimal alignment for each selectable port as described above.

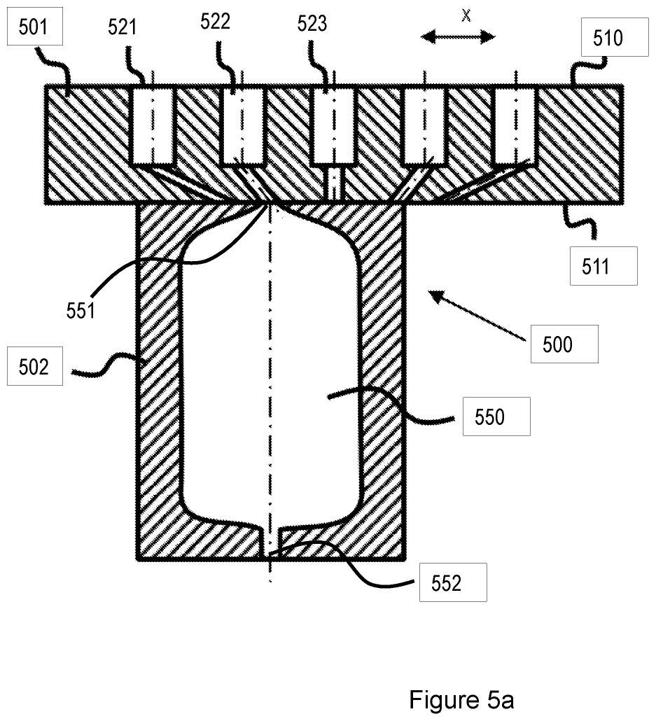

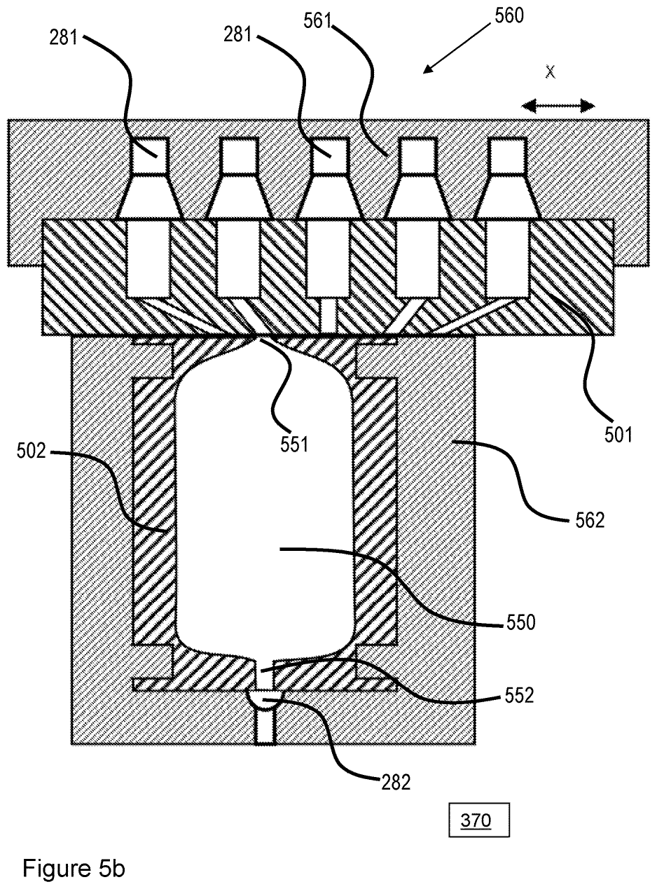

A schematic sectional view of a further example of a linear valve is shown in FIG. 5a. The valve 500 is a multi-port linear slide valve comprising a moveable port plate 501 which is provided with a plurality of linear ports 521, 522, 523. The port plate 501 has a front surface 510 and a rear surface 511 and is linearly displaceable in direction X relative to a connection plate 502 of the valve, which forms the static member of the valve. The connection plate 502 holds a patterned flow-through cell 550, which has an inlet opening 551 that abuts the rear side of the port plate 501, and an outlet opening 552 at an opposite end of the flow-through cell 550. The flow-through cell 550 thus serves as a primary channel of the valve. The linear ports 521, 522, 523 extend through the port plate 501, and comprise a connecting part that extends perpendicular to the front surface 510 and a channel section that extends from the connecting part through to a port opening on the rear side 511 of the port plate. The port plate 501 is displaced in order to bring the port opening of a channel section into alignment with the inlet port opening 551 of the flow-through cell 550. The depicted multi-port linear valve may be used for gene sequencing, whereby the first linear port 521 can provide a solution with DNA fragments, and the other linear ports 522, 523 can provide reagents, such as fluorescence labelled nucleotides.

As may be seen from FIG. 5a, the channel section of one of the linear ports 523 extends collinear with the connecting part of that port, whereas other linear ports 521, 522 have a channel section that extends at an angle with respect to the corresponding connecting part. This reduces the distance between the channel port openings of linear ports in the rear surface 511 of the port plate 501 in the direction of linear displacement X. Consequently, a smaller relative movement between the port plate 501 and the connection plate 502 is required for switching between the linear ports.

To determine the position of optimal centre-to-centre alignment between the inlet port opening of the flow-through cell 550 and the port opening associated with each selectable linear port 521, 522, 523, the valve 500 is calibrated in advance with the aid of a teaching fixture, an example of which is shown in FIG. 5b. The fixture 360 comprises a static part 362 for holding the static part of the valve, i.e. the connection plate 502 and flow-through cell 550, and has a moving part 561 mounted in connection with moveable member of the valve, i.e. port plate 501. The moving part of the fixture 561 and the port plate 501 are mounted in connection with a linear displacement mechanism of the valve, and are displaceable in X-direction relative to the static part. The valve is further provided with a controller for controlling the displacement and a position encoder (not shown) which provides a position signal to the controller.

The moving part of the fixture 561 is further provided with a plurality of acoustic transmitters, each of which is arranged at the front side 511 of the port plate, in closed connection with the associated linear port 521, 522, 523. The static part of the fixture 562 is provided with an acoustic receiver 282, arranged in closed connection with the outlet opening 552 of the flow-through cell.

The arrangement further comprises an analysis device 370, which measures the acoustic signal received by the acoustic receiver 282, while the port plate 502 is displaced relative to the static part of the valve and an acoustic signal is generated by each of the acoustic transmitters. The position of optimal centre-to-centre alignment is determined for each created fluid path, using any of the methods as described with reference to FIGS. 4a and 4b, and is stored in the electronics of the valve controller.

Examples, embodiments or optional features, whether indicated as non-limiting or not, are not to be understood as limiting the invention as claimed. It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### LIST OF REFERENCES AND ABBREVIATIONS

The following list of references and abbreviations is provided for facilitating the interpretation of the drawings and shall not be construed as limiting the claims.

| | |
|---|---|
| 10, 210 | rotary valve |
| 12 | rotor assembly of rotary valve |
| 14, 214 | stator assembly |
| 24 | rotor member |
| 34, 234 | rotary encoder |
| 35 | encoder module |
| 36 | stator member |
| 40 | port member of stator assembly |
| 44a, 244a | central connection port |
| 44b, 244b | radially outer connection ports |
| 245 | threaded insert of a connection port |
| 46, 246 | central stator channel |
| 48, 248 | selectable stator channel |
| 249 | port opening of selectable stator channel |
| 50, 250 | rotor channel |
| 250a | central opening of rotor channel |
| 250b | radially outer port opening of rotor channel |
| 280 | fluid path |
| 281 | acoustic transmitter |
| 282 | acoustic receiver |
| 290 | motor |
| 295 | drive shaft |
| 300 | holder of calibration apparatus |
| 360 | teaching fixture |
| 362 | central protrusion of teaching fixture that fits into valve central |
| | connection port |
| 363 | radially outer protrusion that fits into valve outer connection port |
| 364 | central opening in teaching fixture |
| 365 | central channel section that connects with central stator channel |
| 366 | second, radially outer opening in teaching fixture |
| 367 | second channel section that connects with selectable stator channel |
| 370 | analysis device |
| 400 | linear valve |
| 401 | moveable member of linear valve |
| 402 | static member of linear valve |
| 500 | multiport linear slide valve |
| 501 | port plate of linear slide valve (moveable member) |
| 502 | connection plate of linear slide valve (static member) |
| 510 | front surface of port plate |
| 511 | rear surface of port plate |
| 521, 522, 523 | selectable linear ports |
| 550 | flow-through cell |
| 551 | inlet opening of flow-through cell |
| 552 | outlet opening of flow-through cell |
| 560 | teaching fixture |
| 561 | moving part of teaching fixture |
| 562 | static part of teaching fixture |
| P_{A} | primary port of linear valve |
| P_{B1}, P_{B2}, P_{B3} | selectable secondary port of linear valve |
| R | reference position on static member of linear valve |

1. A method of determining fluid path connectivity for a fluidic device (10, 210, 400, 500) having a static member (14, 214, 402, 502) and a moveable member (24, 224, 401, 501), wherein:
the static member is provided with a first channel (48, 248, P_{B1}, P_{B2}, P_{B3}, 550) having a first port opening (249);
the moveable member is provided with a second channel (50, 250, P_{A}, 521, 522, 523) having a second port opening (250b); and
the first and second channels are interconnectable so as to create at least part of a fluid path (280), the method comprising steps of:
generating an acoustic signal at one end of the fluid path;
receiving the generated acoustic signal at an opposite end of the fluid path;
measuring an acoustic intensity of the received signal; and
moving the moveable member relative to the static member, such that the first and second port openings move into and out of alignment with each other;
wherein the step of measuring the acoustic intensity is performed during the step of moving the moveable member and wherein the method comprises a further step of correlating the measured acoustic intensity with a center-to-center alignment of the first and second port openings.

2. The method of claim 1, wherein the fluidic device is provided with a position encoder (34, 234), which generates a position signal indicative of the position of the moveable member relative to the static member during the step of measuring acoustic intensity and wherein the method comprises a further step of determining a value of the position signal where optimal center-to-center alignment of the first and second port openings is achieved, based on the measured acoustic intensity.

3. The method of claim 2, wherein the fluidic device is a linear valve (400, 500) comprising a linear displacement mechanism to which the moveable member (401, 501) is mounted and a controller for controlling the linear displacement of the moveable member relative to the static member (402, 502) based on a position signal from the position encoder, wherein one of the movable or the static member is provided with a primary channel (P_{A}, 550) the other one of the movable or the static member is provided with a plurality of selectable secondary channels (P_{B1}, P_{B2}, P_{B3}, 521, 522, 523), and a plurality of fluid paths are creatable by moving a port opening (551) of the primary channel into alignment with a port opening of a selected secondary channel or vice-versa, and wherein the method comprises steps of:
displacing the movable member (401, 501);
measuring the acoustic intensity associated with each created fluid path and recording an associated linear position of the movable member, based on the position signal received from the position encoder;
determining a linear position of optimal center-to-center alignment between the port opening of the primary channel and the port opening of each selectable secondary channel, based on the measured acoustic intensity; and
programming the controller with each determined linear position.

4. The method of claim 3, wherein the step of measurement is performed during displacement the moveable member (401, 501) in both forwards and backwards linear directions, and the position of optimal alignment is determined based on an average of the optimal position determined in each direction of linear displacement.

5. The method of claim 3, wherein the step of measurement is performed during displacement of the moveable member (401, 501) in both forwards and backwards linear directions and the position of optimal alignment associated which each direction of linear displacement is determined, and wherein the controller is programmed with the determined linear position, dependent on the direction of displacement.

6. The method of claim 5, wherein the step of measurement is performed during displacement of the moveable member in both forwards and backwards linear directions and the position of optimal alignment is determined as a midpoint between a first linear position at which the measured acoustic intensity rises above a threshold during displacement in one direction and a second linear position at which measured acoustic intensity rises above the threshold during displacement in the opposite direction.

7. The method of claim 3 or 4, wherein the position of optimal alignment is determined as a midpoint between a first linear position at which the measured acoustic intensity rises above a threshold and a second linear position at which the measured acoustic intensity falls below the threshold during linear displacement in the same direction.

8. The method of claim 2, wherein the fluidic device is a rotary valve (10, 210) comprising a rotor member (24, 224) which is drivingly rotatable relative to a stator assembly (14, 214) of the valve, and a controller for controlling the driven rotation, based on an angular position signal from a rotary encoder (34, 234) mounted to the rotor member, whereby the rotor member is provided with a rotor channel (50, 250), the stator assembly is provided with a plurality of selectable stator channels (48, 248), and a plurality of fluid paths are creatable by rotating a port opening (250b) of the rotor channel into alignment with a port opening (249) of a selected stator channel (48, 248), and wherein the method comprises steps of:
rotating the rotor member (24, 224);
measuring the received acoustic signal associated with each created fluid path and recording an associated angular position of the rotor member, based on the position signal received from the encoder (34, 234);
determining an angular position of optimal center-to-center alignment between the port opening (250b) of the rotor channel and the port opening (249) of each selectable stator channel (48, 248), based on the measured acoustic signal; and
programming the controller with each determined angular position.

9. The method of claim 7, wherein the step of measurement is performed during rotation of the rotor member (24, 224) in both clockwise and anticlockwise directions and the position of optimal alignment is based on an average of the optimal angular position determined in each direction of rotation.

10. The method of claim 7, wherein the step of measurement is performed during rotation of the rotor in both clockwise and anticlockwise directions and the position of optimal alignment associated which each direction of rotation is determined and wherein the controller is programmed with the determined angular position, dependent on the direction of rotation.

11. The method of claim 7, wherein the step of measurement is performed during rotation of the rotor member (24, 224) in both clockwise and anticlockwise directions and the position of optimal alignment is determined as a midpoint between a first angular position at which the measured acoustic intensity rises above a threshold during rotation in one direction and a second angular position at which measured acoustic intensity rises above the threshold during rotation in the opposite direction.

12. The method of claim 5 or 6, wherein the position of optimal alignment is determined as a midpoint between a first angular position at which the measured acoustic intensity rises above a threshold and a second angular position at which the measured acoustic intensity falls below the threshold during rotation in the same direction.

13. The method of any preceding claim, wherein the generated acoustic signal is an ultrasonic signal with a frequency greater than 20 KHz.

14. An apparatus for testing and calibration of a rotary valve (10, 210), the rotary valve comprising a rotor member (24, 224) having a rotor channel (50, 250), the rotor member being provided with a rotary encoder (34, 234), the valve further comprising a stator assembly (14, 214) having a central stator channel (46, 246) and plurality of selectable stator channels (48, 248), whereby a plurality of fluid paths are creatable by rotating a port opening (250b) of the rotor channel into alignment with a port opening (249) of a selected stator channel (48, 248), whereby the apparatus comprises an analysis device (370) and a measurement fixture (360) which has a central opening (264, 265) that is connectable to the central stator channel (46, 246) and a corresponding plurality of outer openings (366, 367), each of which is connectable to a corresponding stator channel (48, 248), wherein:
the central opening of the measuring fixture (360) is provided with one of an acoustic transmitter and an acoustic receiver (281, 282);
each outer opening of the measuring fixture is provided with the other of an acoustic receiver and an acoustic transmitter, such that an acoustic signal associated with each created fluid path is measurable; and
the analysis device (370) is configured to measure the acoustic intensity of the received signal during rotation of the rotor port opening (250b) past each selectable stator port opening (249).

15. The apparatus of claim 14, wherein the analysis device (370) is further configured to receive and record a position signal from the rotary encoder during the measurement, and to determine a position of optimal center-to-center alignment for the rotor port opening (250b) and each stator port opening (249) based on the acoustic signal measured for each created fluid path.

16. The apparatus of claim 14, wherein the analysis device (370) is further configured to detect when the measured signal rises above and falls below a threshold, and to provide a corresponding digital high/low signal to the rotary encoder of the valve.

17. An apparatus for testing and calibrating a linear valve, the linear valve comprising a movable member (401, 501) which is drivingly linearly movable, relative to a static member (402, 502), and a position encoder for providing a position signal indicative of the linear position of the moveable member relative to the static member, wherein one of the movable and the static member is provided with a primary channel (P_{A}, 550) the other one of the movable or the static member is provided with a plurality of selectable secondary channels (P_{B1}, P_{B2}, P_{B3}, 521, 522, 523) and a plurality of fluid paths is creatable by linearly moving a port opening (551) of the primary channel into alignment with a port opening of a selected secondary channel or vice-versa, the apparatus comprising a measurement fixture (560) having a static fixture (562) for holding the static member of the valve and a moving fixture (561) for holding the moveable member of the valve, wherein the measurement fixture (560) comprises:
one of an acoustic transmitter (281) and an acoustic receiver (282), arranged in closed connection with the primary channel;
the other of an acoustic transmitter and an acoustic receiver, arranged in closed connection with each selectable secondary channel;
and wherein the apparatus further comprises an analysis device (370) configured to measure the acoustic intensity of the received signal associated with each created fluid path during linear displacement of the moveable member (401, 501).

18. The apparatus of claim 17, wherein the analysis device (370) is further configured to receive and record the position signal from the position encoder during the measurement, and to determine a position of optimal center-to-center alignment for the port opening of the primary channel and the port opening of each secondary channel, based on the acoustic signal measured for each created fluid path.

19. The apparatus of claim 17, wherein the analysis device (370) is further configured to detect when the measured signal rises above and falls below a threshold, and to provide a corresponding digital high/low signal to the position encoder of the linear valve.
